(19) United States
(12) Patent Application Publication
(10) Pub. No.: US 2026/0057474 A1
(43) Pub. Date: Feb. 26, 2026

(54) HYBRID DYNAMIC NON-LINEAR DISPLAY FOR USE WITH ELECTRONIC FLIGHT INSTRUMENT SYSTEMS

(71) Applicant: Marinvent Corporation, Saint-Bruno (CA)

(72) Inventor: John Maris, Beaconsfield (CA)

(21) Appl. No.: 19/307,522

(22) Filed: Aug. 22, 2025

Related U.S. Application Data
(60) Provisional application No. 63/687,178, filed on Aug. 26, 2024.

(51) Int. Cl. G06T 3/40; B64D 43/02; G06T 11/20; G06T 13/00

(52) U.S. Cl. CPC G06T 3/40; B64D 43/02; G06T 11/206; G06T 13/00; G06T 2200/24

(57) ABSTRACT

An electronic instrument system is described herein. The electronic instrument system includes a display device including a graphical user interface (GUI) display screen displaying computer-generated images thereon and a controller operably coupled to the display device. The controller includes one or more processors programmed to execute an algorithm to display an animated sequence of computer-generated images on the GUI display screen including the steps of receiving a current parameter value and rendering a parameter display screen on the GUI display screen including a hybrid dynamic non-linear display displaying the current parameter value. The one or more processors render the hybrid dynamic non-linear display including a parameter display tape including a linear scale region displayed between a first non-linear scale region and a second non-linear scale region along a scale axis.

### CROSS-REFERENCE TO RELATED APPLICATIONS

The present application claims priority to and all the benefits of U.S. Provisional Patent Application No. 63/687,178, filed on Aug. 26, 2024, the entire contents of which are expressly incorporated herein by reference.

### COPYRIGHT NOTICE

The figures included herein contain material that is subject to copyright protection. The copyright owner has no objection to the facsimile reproduction by anyone of this patent document as it appears in the U.S. Patent and Trademark Office, patent file or records, but reserves all copyrights whatsoever in the subject matter presented herein.

### BACKGROUND OF THE INVENTION

### Field of the Invention

The present invention relates to electronic flight instrument systems (EFIS), and more particularly, to systems, methods, and computer-readable storage media for rendering parameter displays for use with electronic flight instrument systems.

### Description of the Related Art

At least some known cockpit primary flight displays (PFD) present a multitude of information, principally related to the control and supervision of the desired aircraft trajectory. The former is a tactical task which involves relatively tight control and tracking of a desired parameter, such as aircraft altitude. The latter is a broader strategic task which entails the maintenance of proper Situational Awareness (SA) by the pilot, which may be defined as: Level 1: Perception of the elements in the environment; Level 2: Comprehension of the current situation; and Level 3: Projection of the future status. The basic PFD depictions of airspeed, altitude, vertical speed, and heading directly address Level 1 SA for their respective parameters, but they provide limited Level 2 and Level 3 information as they represent a “snapshot” of the instantaneous aircraft trajectory. Hiremath et al. note that trend information is also difficult to obtain from tape displays. Rate-aiding trend vectors and preselector “bugs” are often added to airspeed and altitude tape displays in an effort to provide projection (i.e., Level 3) information, but this capability is compromised with conventional displays, because the values are often “parked” off-scale due to the limited range of linear scales. This is sometimes addressed by presenting the saturated value in numerical format. The saturation of linear scales and their predictors exemplifies their basic shortcoming: there is an inevitable trade-off between scale range, scale resolution, and display legibility. Optimization of any pair of these elements must be at the expense of the third, or other concessions. This compromise is unavoidable with mechanical instruments, where the scale parameters are fixed by the display mechanism.

At least some known cockpit primary flight displays include round-dial mechanical instruments. However, as aircraft performance increased and flight envelopes expanded, this imposed increasing challenges on these “steam” gauges. Tape displays have gradually supplanted round-dial displays in Electronic Flight Instrument Systems (EFIS) applications, and they have been widely adopted in aircraft cockpits since the 1970s. Non-linear display markings have been part of aviation since its earliest day, and some of these early designs have shown considerable creativity in addressing the human factors challenges of mechanical instruments. The earliest tape displays were aptly named, as they used physical “tapes,” spooled through bobbins inside the instrument. Due to the conservative character of aviation progress, the first EFIS displays contained simple pictorial representations of their round-dial electro-mechanical forebears.

At least some known tape displays share a common trait: the display scale, whether linear or non-linear, is static, forcing the compromise that has already been discussed. The problem is least evident for engine instruments, which have a relatively fixed and narrow operating range, although some newer systems change the scale display to accommodate the different requirements of a turbine start cycle. Airspeed scales have proven more challenging, particularly for high performance applications, because of the need for high resolution (±1 knot, typically) over a very broad range. For this reason, tape airspeed displays usually have a narrow scale range of the order of ±30 knots. The tape display of aircraft altitude is even more challenging, because of a typical required operating range from sea-level to 50,000+ feet and a required resolution of ±20 feet. Typical EFIS tape altimeters have a maximum scale range of approximately ±500 feet, so the majority of the aircraft's altitude envelope is always out of view, and the ground is usually not visible until the aircraft is at low altitudes—below 2,500 ft AGL in some cases, and 500 ft in others.

The present invention is aimed at one or more of the problems identified above.

### SUMMARY OF THE INVENTION

In one aspect of the present invention, an electronic instrument system is provided. The electronic instrument system includes a display device including a graphical user interface (GUI) display screen displaying computer-generated images thereon and a controller operably coupled to the display device. The controller includes one or more processors programmed to execute an algorithm to display an animated sequence of computer-generated images on the GUI display screen including the steps of receiving a current parameter value and rendering a parameter display screen on the GUI display screen including a hybrid dynamic non-linear display displaying the current parameter value. The one or more processors render the hybrid dynamic non-linear display by establishing an upper end point anchor value and a lower end point anchor value based on the current parameter value and rendering a parameter display tape including a parameter scale displaying the upper end point anchor value and the lower end point anchor value and including a linear scale region displayed between a first non-linear scale region and a second non-linear scale region along a scale axis. A plurality of linear tick-marks are equally spaced within the linear scale region, a plurality of first non-linear tick-marks are unequally spaced within the first non-linear scale region, and a plurality of second non-linear tick-marks are unequally spaced within the second non-linear scale region.

In another aspect of the present invention, a method of operating an electronic instrument system is provided. The electronic instrument system includes a display device including a graphical user interface (GUI) display screen displaying computer-generated images thereon and one or more processors operably coupled to the display device. The method includes the one or more processors performing an algorithm to display an animated sequence of computer-generated images on the GUI display screen including the steps of receiving a current parameter value and rendering a parameter display screen on the GUI display screen including a hybrid dynamic non-linear display displaying the current parameter value. The one or more processors render the hybrid dynamic non-linear display by establishing an upper end point anchor value and a lower end point anchor value based on the current parameter value and rendering a parameter display tape including a parameter scale displaying the upper end point anchor value and the lower end point anchor value and including a linear scale region displayed between a first non-linear scale region and a second non-linear scale region along a scale axis. A plurality of linear tick-marks are equally spaced within the linear scale region, a plurality of first non-linear tick-marks are unequally spaced within the first non-linear scale region, and a plurality of second non-linear tick-marks are unequally spaced within the second non-linear scale region.

In yet another aspect of the present invention, a non-transitory computer-readable storage media having computer-executable instructions embodied thereon for operating an electronic instrument system is provided. The electronic instrument system includes a display device including a graphical user interface (GUI) display screen displaying computer-generated images thereon and one or more processors operably coupled to the display device. When executed by the one or more processors the computer-executable instructions cause the one or more processors to perform an algorithm to display an animated sequence of computer-generated images on the GUI display screen including the steps of receiving a current parameter value and rendering a parameter display screen on the GUI display screen including a hybrid dynamic non-linear display displaying the current parameter value. The one or more processors render the hybrid dynamic non-linear display by establishing an upper end point anchor value and a lower end point anchor value based on the current parameter value and rendering a parameter display tape including a parameter scale displaying the upper end point anchor value and the lower end point anchor value and including a linear scale region displayed between a first non-linear scale region and a second non-linear scale region along a scale axis. A plurality of linear tick-marks are equally spaced within the linear scale region, a plurality of first non-linear tick-marks are unequally spaced within the first non-linear scale region, and a plurality of second non-linear tick-marks are unequally spaced within the second non-linear scale region.

### BRIEF DESCRIPTION OF THE DRAWINGS

Other advantages of the invention will be readily appreciated as the same becomes better understood by reference to the following detailed description when considered in connection with the accompanying drawings, wherein:

FIG. 1 is a schematic diagram illustrating various aspects of a networked computer system for use in generating hybrid dynamic non-linear display for use with electronic flight instrument systems, according to embodiments of the present invention;

FIGS. 2 and 3 are schematic diagrams of an electronic flight instrument systems for use in generating hybrid dynamic non-linear displays, according to embodiments of the present invention;

FIG. 4 is a flowchart illustrating an algorithm executed by the networked computer system for use in generating a hybrid dynamic non-linear display, according to embodiments of the present invention;

FIGS. 5-11 are illustrations of graphical computer images displaying exemplary graphical user interface screens including hybrid dynamic non-linear displays for use with electronic flight instrument systems, according to embodiments of the present invention;

FIG. 12 is an illustration of a graphical user interface screen displaying a computer simulated aircraft and electronic flight instrument system with hybrid dynamic non-linear displays, according to embodiments of the present invention;

FIG. 13 is an illustration of a graphical user interface screen displaying an industrial plant instrument system displaying a process control display including a temperature hybrid dynamic non-linear display indicating measured temperature, according to embodiments of the present invention; and

FIG. 14 is an illustration of a graphical user interface screen displaying an industrial plant instrument system displaying the process control display including a pressure hybrid dynamic non-linear display indicating measured pressure, according to embodiments of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION OF THE INVENTION

With reference to the figures and in operation, the present invention provides a networked computer system 10, methods and non-transitory computer-readable storage media for use in generating hybrid dynamic non-linear displays 12 used with electronic flight instrument systems 14. The hybrid dynamic non-linear display (Hybrid DNLD) 12 of the present invention adds several important enhancements over known electronic flight instrument systems including: 1) methods for the incorporation of central linear zones; 2) the use of three types of end-point anchors; 3) the treatment of scale gradients; 4) the use of Cubic Spline or Bezier algorithms; 5) mechanisms for showing and hiding intermediate markings and indices; and 6) treatment of matching interdependent scales. Each of these enhancements is addressed herein.

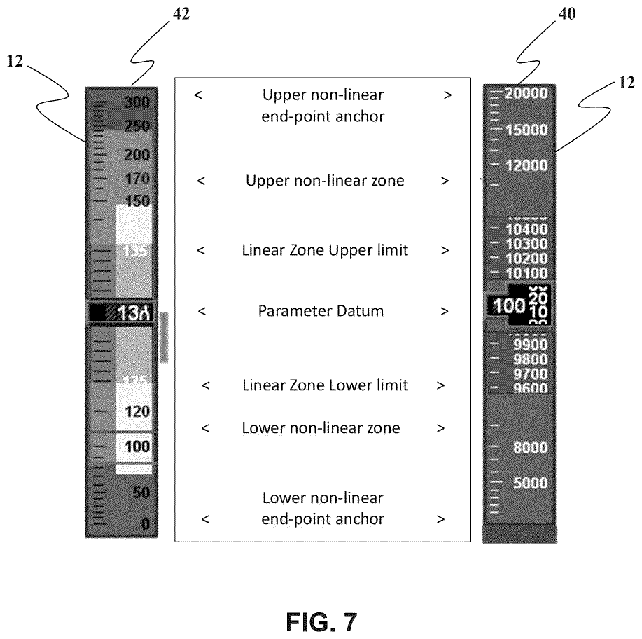

Central Linear Zones: A key disadvantage of traditional fully non-linear scales is the lack of a method for incorporating a linear scale zone, which greatly facilitates parametric control of the vehicle or process by a human operator, as compared to non-linear scales. Accordingly, the current invention incorporates a linear region between the two non-linear zones. The three regions may occupy varying portions of the tape range, but for illustration purposes, one-third of the display tape is devoted to each of the linear and dual non-linear zones, as shown in FIG. 7. The combination of linear and non-linear zones in a single DNLD device is termed a “Hybrid” display.

End-Point Anchors: The end-point anchors (EPA) are key elements of the Hybrid DNLD, as they define the extreme upper and lower extremes of the Hybrid DNLD tape. Proper selection of the EPA values is pivotal to deriving the greatest DNLD benefits. Three types of EPA are explicitly addressed in the new Hybrid DNLD invention: Fixed EPA, Adaptive EPA, and Floating EPA.

Fixed EPAs: Fixed EPAs are static, as exemplified by the display of compass information: all compass readings must lie within ±180° of the current value, so the fixed EPAs are displaced by this amount from the datum (current) compass reading, as shown in FIG. 6. The fixed EPAs embodied in a Hybrid DNLD compass display.

Adaptive EPAs: Adaptive EPAs are generally static but adapt as the limits are approached to accommodate the requirement for a greater range. The display of airspeed information is best accommodated by adaptive EPAs, where the default values include the lowest displayable airspeed up to the maximum permissible airspeed. The upper EPA increases as the airspeed approaches the maximum value, and contracts to its original preset values when the airspeed decreases back into the normal operating range again.

Floating EPAs: Floating EPAs adjust constantly, depending on the parameter value. Aircraft altitude is best displayed using a floating EPA implementation. The very broad potential range of displayed aircraft altitude makes the use of fixed end-points sub-optimal. Different upper and lower EPAs can be used as required by the particular value being displayed. For example, the lower altitude EPA is usually selected to display sea-level with the capability for expansion to allow the display of elevations below sea-level, while the upper limit is set to some convenient value, such as twice the current aircraft altitude, with a minimum value (e.g., 5,000 ft) set to ensure a usable range even at very low aircraft altitudes.

Scale Gradients: The introduction of a linear zone between the two non-linear zones in the Hybrid DNLD introduces a potentially undesirable scale discontinuity across the two transitions between these regions. This can be avoided by forcing the scale at the two intersections to be consistent in both regions immediately adjacent to the transition. In general, the scaling of the linear region is dictated by operational requirements, such as necessary resolution, and this sets the scale at the start of the non-linear zones. More explicitly, the first derivative of the scale gradient is made equal on both sides of the transition point from the linear to the non-linear regions.

The upper and lower non-linear scales connect the linear zone with their respective EPAs to cover the full range for the parameter being displayed. The non-linear scales are therefore defined by the end-points of the non-linear scale and adjacent EPAs.

From these characteristics, it can be seen that the upper and lower scales are not necessarily symmetrical, because the two EPA's that define their endpoints may not be equally spaced from the current parameter value. For example, at high aircraft speeds, the airspeed parameter will be closer to the maximum aircraft speed than the minimum displayable airspeed EPA. Conversely, the non-liner scales would be symmetrical for a typical DNLD heading display, where both EPAs are ±180° from the current heading value.

Cubic Spline and Bézier Algorithms: The mathematical definition of the non-linear scale can take many forms, such as polynomial, logarithmic, exponential or trigonometric. The current implementation uses quadratic or higher order Bézier curves to satisfy the preceding scale requirements. Bézier curves have several advantages for this application: unlike log scales, they can display zero values; they are smooth and can be scaled indefinitely; furthermore, their start and end points are tangent to the first and last section of the defining Bézier polygon, thereby avoiding slope discontinuities at the curve end-points. For these reasons, Béziers are used extensively to smooth animation trajectories in user interface design—a close parallel to the scale animation characteristics required for DNLD.

Intermediate Markings: An emergent Hybrid DNLD characteristic is the need to make intermediate scale markings (tick-marks and captions) appear and disappear in the middle of the non-linear scale regions to properly reflect the full range of the possible displayed values. This is in contrast to conventional linear scales, where numbers and markings also appear and disappear, but at the scale extremes in this case.

The appearance and disappearance of the intermediate scale markings could be distracting, so the invention employs the use of fade-in and fade-out of these “phantom” markings over a period of 2-3 seconds, for example, to minimize any distracting influence.

A related issue concerned the selection of which intermediate markings to display; the invention addresses this issue using a number of heuristics: 1) The parameter values should be distributed relatively uniformly across the non-linear zones to avoid voids and clutter, thereby aiding legibility and usability. 2) Critical values must be displayed at all times (e.g., thousand-foot markers near the current altitude, 5,000 foot markers, etc.). 3) Phantom markings cannot display arbitrary or meaningless values. For example, the Hybrid DNLD algorithms might compute an intermediate non-linear altitude marking at 13,963 feet, but the pilot would clearly not be interested in such a marking.

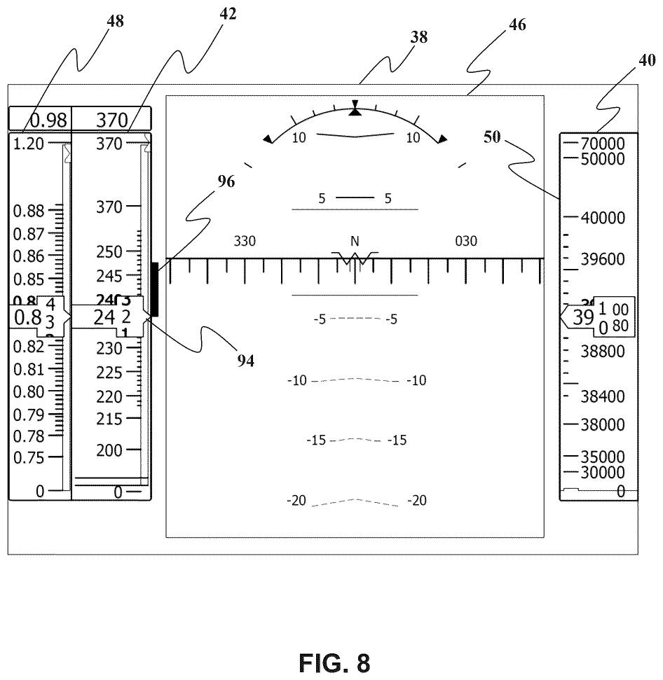

Interdependent Scales: There are occasions where it may be desirable to present two scales showing similar, but not identical, parameters immediately adjacent to each other. This is compounded if the relationship between the scales changes as a result of a third parameter's variation. For example, aircraft Mach number (M) is a function of true airspeed (TAS) and temperature (T), but the latter changes with altitude. Accordingly, a DNLD Mach scale must be constantly adjusted to maintain a correct relationship with the DNLD airspeed markings as altitude changes, as illustrated in FIG. 8. This is achievable using the DNLD techniques already described, but it does apply an additional constraint on the scale calibrations.

The invention uses the following mechanism to harmonize adjacent scales with each other: 1) One of the two scales is designated as “Master” (e.g., Airspeed). 2) The normal DNLD calculations are performed to generate the EPAs, linear, and two non-linear zones for the Master scale. 3) The secondary (“Slave”) display (e.g., Mach) is drawn with EPAs corresponding to the Master scale values. 4) The Slave display markings are calculated and drawn for the Slave display such that the correct relationship is maintained between the Master and Slave display markings.

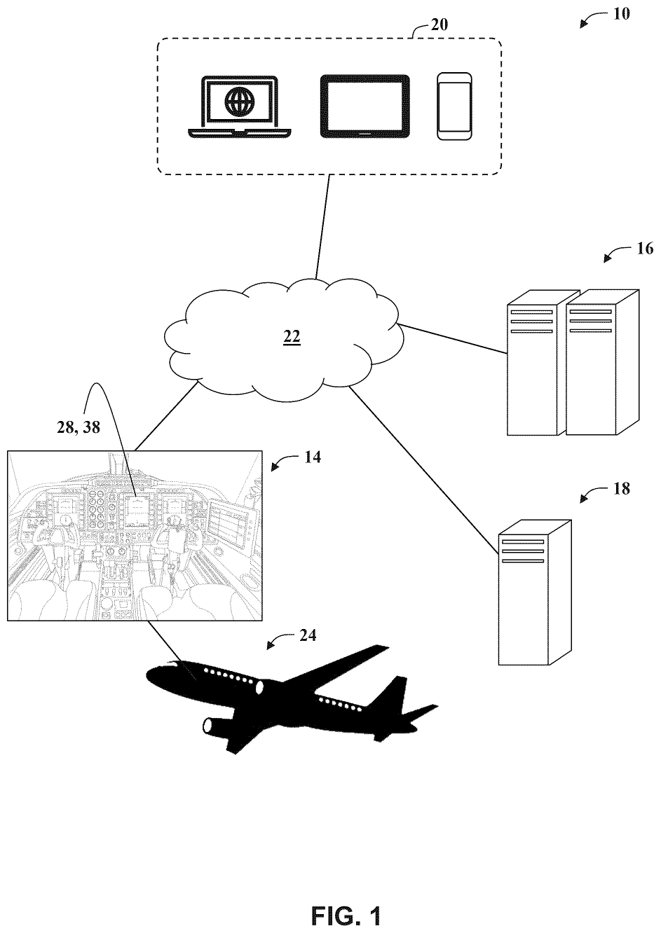

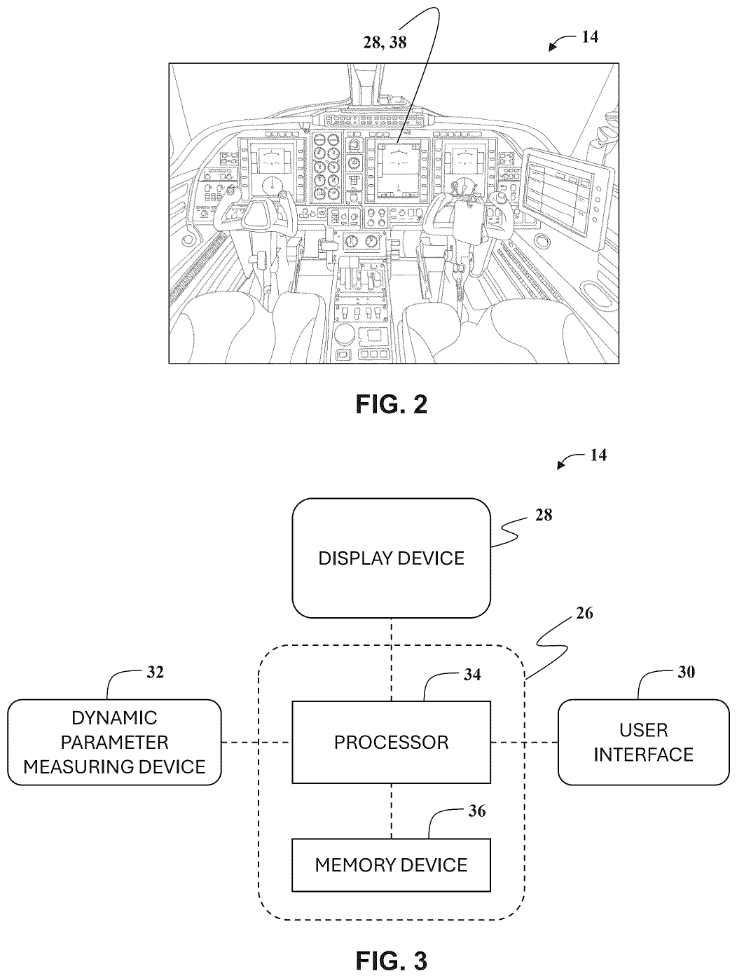

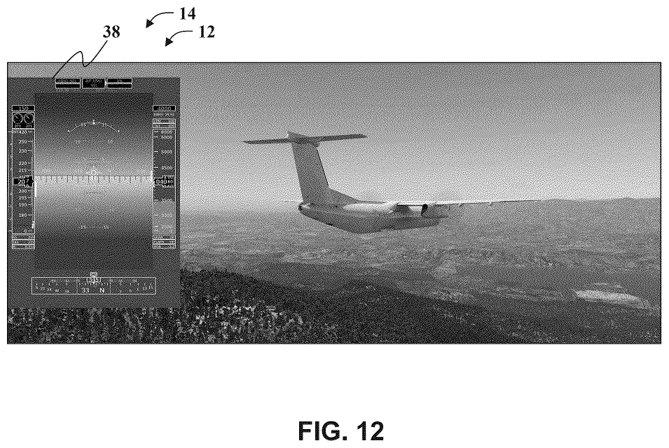

Referring to FIGS. 1-3, in the illustrated embodiment, the networked computer system 10 includes a flight computer server 16 that is coupled in communication with an electronic flight instrument system 14, a website hosting server 18, and a plurality of user computing devices 20 via a communications network 22. In some embodiments, the electronic flight instrument system 14 may be housed within an aircraft 24 to enable a pilot to operate the aircraft 24. In other embodiments, the electronic flight instrument system 14 may be included within a simulated aircraft environment (shown in FIG. 2) to enable pilots to train on the operation of an aircraft 24 using the electronic flight instrument system 14. In other embodiments, the system 10 may be programmed to generate and display a computer-simulated electronic flight instrument system 14 using computer-generated images for use in a computer-simulated video game (shown in FIG. 12).

The communications network 22 may be any suitable connection, including the Internet, file transfer protocol (FTP), an Intranet, LAN, a virtual private network (VPN), cellular networks, etc. . . . , and may utilize any suitable or combination of technologies including, but not limited to wired and wireless connections, always on connections, connections made periodically, and connections made as needed.

Each computer system and/or server may include one or more server computers that each include a processing device that includes a processor that is coupled to a memory device. The processing device executes various programs, and thereby controls components of the server according to user instructions received from the user computing devices 20, the electronic flight instrument system 14, and/or other servers. The processing device may include memory, e.g., read only memory (ROM) and random access memory (RAM), storing processor-executable instructions and one or more processors that execute the processor-executable instructions.

Each user computing device 20 includes a display device for rendering computer-generated graphics and a processing device that includes a processor that is coupled to a memory device. The processing device executes various programs, and thereby controls components of the computing device according to user instructions received by the user to enable the user to access and communicate with the networked computer system 10 including sending and/or receiving information to and from the networked computer system 10 and displaying information received from the system 10 to the user.

For example, in some embodiments, the user computing device 20 may include, but is not limited to, a desktop computer, a laptop or notebook computer, a tablet computer, smartphone/tablet computer hybrid, a personal data assistant, a handheld mobile device including a cellular telephone, and the like. In addition, the user computing device 20 may include a touchscreen that operates as the display device and the user input device. In the illustrated embodiment, the user computing device 20 includes a web-browser program that is stored in the memory device. When executed by the processor of the user computing device, the web-browser program enables the user computing device 20 to receive software code from the website hosting server 18 including, but not limited to HTML, JavaScript, and/or any suitable programming code that enables the user computing device to generate and display a website and/or webpages on the display device of the user computing device 18. The web-browser program also enables the user computing device 18 to receive instructions from the website hosting server 16 that enable the user computing device 18 to render HTML code for use in generating and displaying portions of the website and/or webpage.

The website hosting server 18 is programmed to host a website including webpages that is accessible by a user via one or more user computing devices 18. The website hosting server 18 executes a website application program that executes computer application code including the software components to render one or more webpages on a display device of a user computing device 20 in response to requests received from the user via the user computing device 20 to allow users to interact with the website.

For example, in some embodiments, the flight computer server 16 may be programmed to display simulated video computer images of the electronic flight instrument systems 14 to user computing devices 20 via webpages generated by the website hosting server 18 to enable users to simulate flying a video simulated aircraft 24 using the video simulated electronic flight instrument systems 14 (shown in FIG. 12).

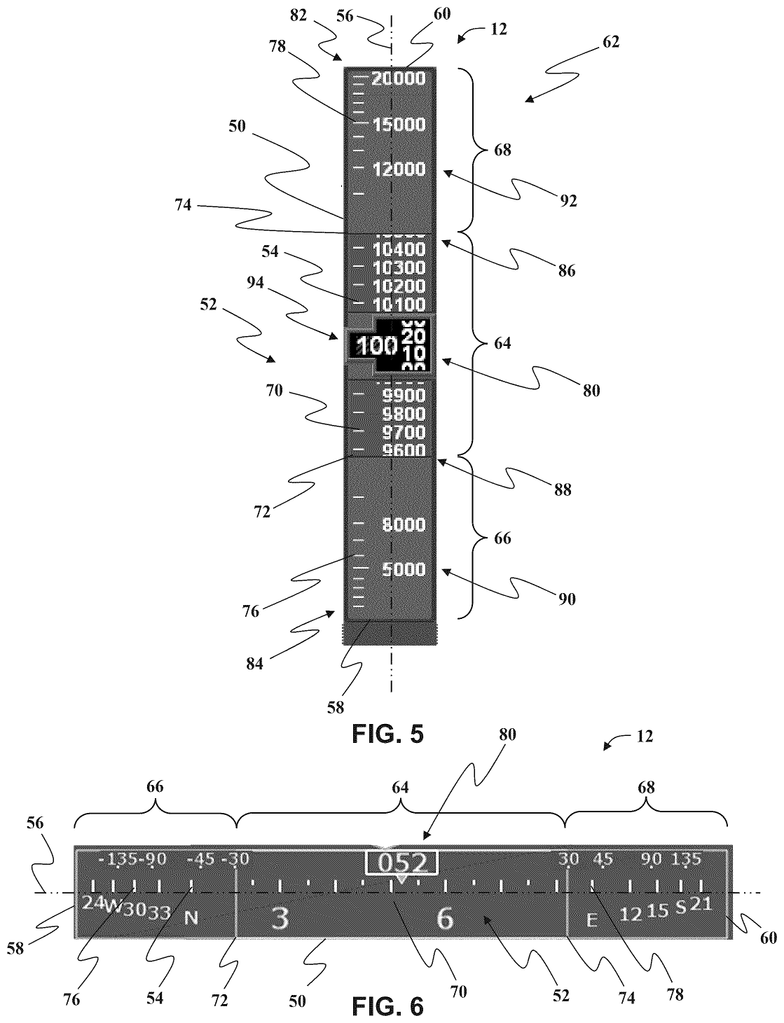

In the illustrated embodiment, the electronic flight instrument system 14 includes a controller 26 operably coupled to a display device 28, a user interface 30, and a dynamic parameter measuring device 32. The display device 28 includes a graphical user interface (GUI) display screen displaying computer-generated images (shown in FIGS. 5-12). For example, the display device 28 may include a multifunction Display (MFD), a Head-Up Display (HUD), or any suitable display device for use in rendering computer-generated images. The user interface 30 is configured to receive input parameters from the user for use in operating the electronic flight instrument system 14 and may include an instrument panel, a touch screen, and/or any suitable input device that enables the controller 26 to receive inputs from the user.

The dynamic parameter measuring device 32 is configured to receive measured operating parameters associated with the aircraft 24 such as, for example, altitude, heading, airspeed, and/or any suitable operating parameter associated with the operation of the aircraft 24.

The controller 26 includes one or more processors 34 coupled to a memory device 36. The processor 34 is programmed to execute computer-executable instructions stored in the memory device 36 to execute an algorithm to receive operating parameter values from the dynamic parameter measuring device 32 and display an animated sequence of computer-generated images on the display device 28 based on the receive operating parameter values. Additional details of an electronic flight instrument system which may be used in the present invention, are described in U.S. patent application Ser. No. 10/670,780 to John Maris, filed Sep. 26, 2003, titled “Electronic Non-Linear Aircraft Dynamic Parameter Display”, and U.S. patent application Ser. No. 11/412,904 to John Maris, filed Apr. 28, 2006, titled “Dynamic Non-Linear Display”, which are incorporated herein by reference in their entirety.

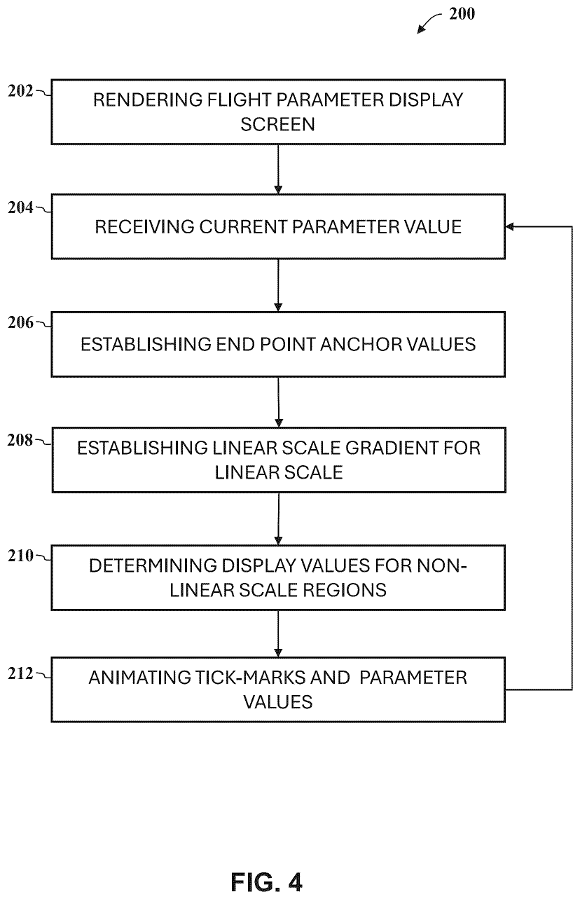

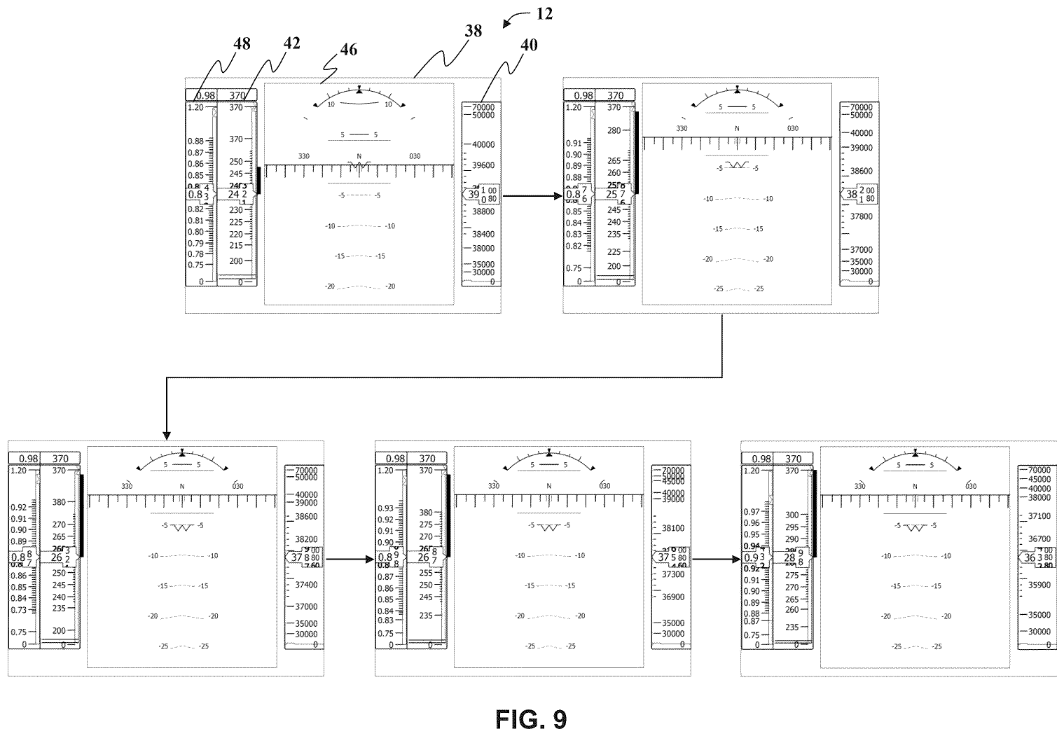

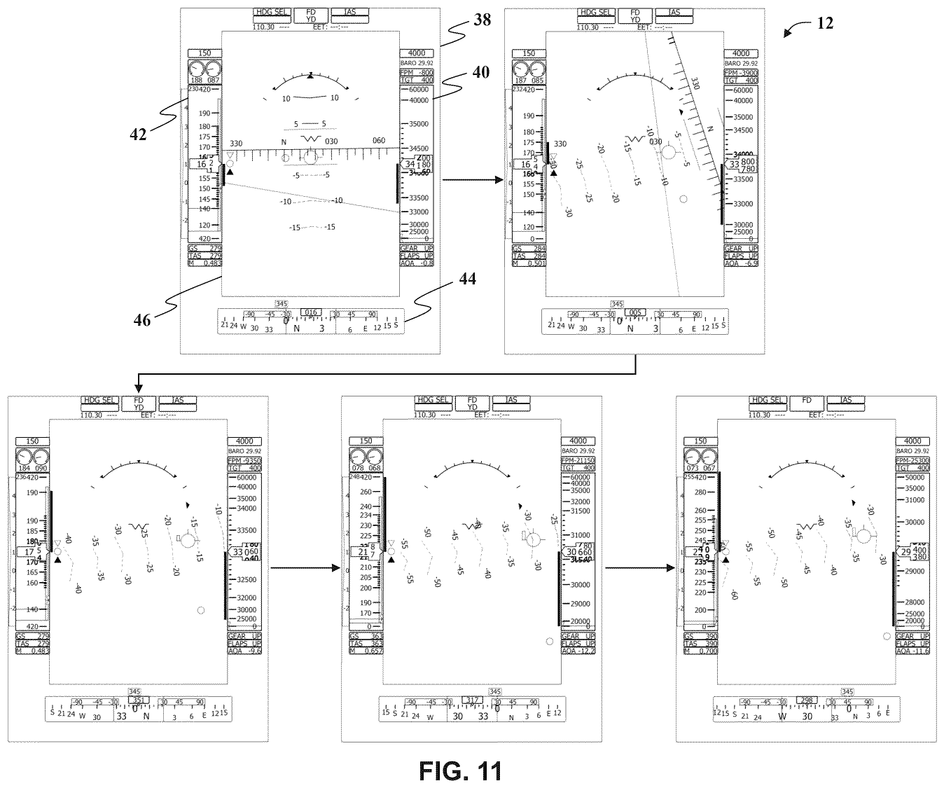

FIG. 4 is a flowchart illustrating an algorithm 200 executed by the processor 34 for use in generating hybrid dynamic non-linear displays. FIGS. 5-12 are illustrations of exemplary hybrid dynamic non-linear displays 12 generated by the processor 34 when performing the algorithm 200. FIGS. 9 and 11 are illustrations of sequences of graphical computer images displaying exemplary graphical user interface screens including hybrid dynamic non-linear displays 12 displayed on the display devices of the electronic flight instrument systems 14 and/or user computing devices 20.

The algorithm 200 includes a plurality of steps. Each algorithm step may be performed independently of, or in combination with, other algorithm steps. Portions of the algorithm may be performed by any one of, or any combination of, the components of the system 10.

In the illustrated embodiment, in method step 200, the processor 34 renders a flight parameter display screen 38 on the display device 28 including one or more hybrid dynamic non-linear displays 12 indicating a measured operating parameter associated with the operation of the aircraft 24. For example, as shown in FIGS. 5-12, the processor 34 may render the flight parameter display screen 38 including a plurality of hybrid dynamic non-linear displays 12 including an altimeter hybrid dynamic non-linear display 40 indicating measured aircraft altitude, airspeed hybrid dynamic non-linear display 42 indicating measure aircraft airspeed, and a compass hybrid dynamic non-linear display 44 indicating measured aircraft heading. The processor 34 may also render the flight parameter display screen 38 including a Pitch/Roll display window 46 displayed between the altimeter hybrid dynamic non-linear display 40 and the airspeed hybrid dynamic non-linear display 42 indicating a pitch and roll of the aircraft 24. As shown in FIG. 8, the processor 34 may also render the flight parameter display screen 38 including a MACH hybrid dynamic non-linear display 48 indicating the determined MACH number associated with the measured aircraft airspeed.

In the illustrated embodiment, the processor 34 displays the hybrid dynamic non-linear display 12 including a parameter display tape 50. The parameter display tape 50 includes a parameter scale 52 including a plurality of tick-marks 54 spaced along a scale axis 56 between a first scale end 58 and an opposite second scale end 60. The parameter scale 52 includes a plurality of scale regions 62 defined between the first and second scale ends 58, 60.

For example, as shown in FIGS. 5 and 6, the plurality of scale regions 62 may include a linear scale region 64 displayed between a first non-linear scale region 66 and a second non-linear scale region 68. The linear scale region 64 includes linear tick-marks 70 that are equally spaced along the scale axis 56 within the linear scale region 64 between a first linear scale end 72 and an opposite second linear scale end 74. The first non-linear scale region 66 includes first non-linear tick-marks 76 that are unequally spaced along the scale axis 56 within the first non-linear scale region 66 such that first non-linear tick-marks 76 displayed near the first end 58 of the parameter scale 52 are spaced closer together than first non-linear tick-marks 76 displayed near the first linear scale end 72 of the linear scale region 64. The second non-linear scale region 68 includes second non-linear tick-marks 78 that are unequally spaced along the scale axis 56 within the second non-linear scale region 68 such that second non-linear tick-marks 78 displayed near the second end 60 of the parameter scale 52 are spaced closer together than second non-linear tick-marks 78 displayed near the second linear scale end 74 of the linear scale region 64. In some embodiments, the processor 34 displays each scale region 62 having the same length defined along the scale axis 56. For example, the processor 34 may display each scale region 62 to occupy one-third of the length of the parameter scale 52 defined along the scale axis 56. In other embodiments, the processor 34 may display one or more scale regions having a length defined along the scale axis that is different than another scale region 62.

In method step 204, the processor 34 receives a current parameter value and animates the hybrid dynamic non-linear display 12 based on the received current parameter value 80. For example, the processor 34 may continuously receive current parameter values associated with the operation of the aircraft and dynamically animate the hybrid dynamic non-linear display 12 based on the received current parameter values. In some embodiments, the processor 34 may receive the current parameter value from the dynamic parameter measuring device 32. In other embodiments, the processor 34 may retrieve the current parameter value from a plurality of parameter values stored in the memory device 36. For example, in some embodiments, the processor 34 may continuously receive measured parameter values from the dynamic parameter measuring device 32 and store the received measured parameter values in the memory device 36. The processor 34 may then periodically select a current parameter value from the stored measured parameter values for use in animating the hybrid dynamic non-linear display 12.

In method step 206, the processor 34 establishes an upper end point anchor value 82 and a lower end point anchor value 84 associated with the parameter scale 52. For example, in some embodiments, the processor 34 may receive predefined end point anchor values associated with a corresponding measured parameter from a user via the user interface 30 and store the user-selected end point anchors in the memory device 36. The processor 34 may then access the predefined end point anchor values for use in generating the parameter scale 52. In other embodiments, the processor 34 may establish the upper and lower end point anchor values 82, 84 based on the current parameter value 80.

In method step 208, the processor 34 establishes a linear scale gradient (e.g., a spacing between tick marks) of the linear scale region 64 for use in displaying the equally spaced linear tick-marks 70. The processor 34 then determines an upper linear scale value 86 and a lower linear scale value 88 of the linear scale region 64 based on the received current parameter value 80 and the linear scale gradient.

In method step 210, the processor 34 determines display values for the non-linear scale regions 66, 68. For example, the processor 34 may determine a plurality of first display values 90 associated with the first non-linear scale region 66 based on the lower end point anchor value 84 and the lower linear scale value 88 of the linear scale region 64. The processor 34 may also determine a plurality of second display values 92 associated with the second non-linear scale region 68 based on the upper end point anchor value 82 and the upper linear scale value 86 of the linear scale region 64.

In some embodiments, the processor 34 may determine the first and second display values 90, 92 using a quadratic Bézier curve. For example, the processor 34 may be programmed to execute a parametric equation for a display parameter B_{L}(t) on the lower non-linear region 66 of a quadratic Bézier curve using:

$${B}_{L} ( t ) = {P}_{L} + ( 1 - {t}^{2} ) ( {LZ}_{L} - {P}_{L} ) + {t}^{2} ( {EPA}_{L} - {P}_{L} ) where \qquad Equation ( 1 )$$

$$0 \leq t \leq 1$$

### Where:

B_{L}(t) is the Bézier display value for the first non-linear region 66, in parametric form;
EPA_{L} is the lower End Point Anchor;
LZ_{L} is the lower extreme value of the linear zone;
P_{L} is the parameter that defines the quadratic Bézier curve; and
t is the control parameter that sweeps the Bézier curve from LZ_{L} to EPA_{L}.

Similarly, the processor 34 may be programmed to execute a parametric equation for a display parameter B_{U}(t) on the upper non-linear region 68 of a quadratic Bézier curve using:

$${B}_{U} ( t ) = {P}_{U} + ( 1 - {t}^{2} ) ( {LZ}_{U} - {P}_{U} ) + {t}^{2} ( {EPA}_{U} - {P}_{U} ) where \qquad Equation ( 2 )$$

$$0 \leq t \leq 1$$

### Where:

B_{U}(t) is the Bézier display value for the second non-linear region 68, in parametric form;
EPA_{U} is the upper End Point Anchor;
LZ_{U} is the lower extreme value of the linear zone;
P_{U} is the parameter that defines the quadratic Bézier curve; and
t is the control parameter that sweeps the Bézier curve from LZ_{U} to EPA_{U}.

The derivative of the lower Bézier curve is given by:

$${B}_{L}^{′} ( t ) = 2 ( 1 - t ) ( {P}_{L} - {LZ}_{L} ) + 2 t ( {EPA}_{L} - {P}_{L} ) \qquad Equation ( 3 )$$

The corresponding derivative for the upper Bézier curve is given by:

$${B}_{U}^{′} ( t ) = 2 ( 1 - t ) ( {P}_{U} - {LZ}_{U} ) + 2 t ( {EPA}_{U} - {P}_{U} ) \qquad Equation ( 4 )$$

By definition, (t)=0 at the intersections of the linear scale region 64 and the non-linear scale regions 66, 68, the derivatives at these points reduce to:

$${B}_{L}^{′} ( t ) = 2 ( {P}_{L} - {LZ}_{L} ) \qquad Equation ( 5 )$$

$${B}_{U}^{′} ( t ) = 2 ( {P}_{U} - {LZ}_{U} ) \qquad Equation ( 6 )$$

Because the linear zone only has a single scale, the non-linear scale gradients at these points must equal each other (B_{L}′(t)=B_{U}′(t)) and both must equal the gradient of the linear region. Accordingly:

$$( {P}_{L} - {LZ}_{L} ) = ( {P}_{U} - {LZ}_{U} ) \qquad Equation ( 7 )$$

Rearranging:

$$( {LZ}_{U} - {LZ}_{L} ) = ( {P}_{U} - {P}_{L} ) \qquad Equation ( 8 )$$

Equation (8) defines a simple relationship between the constantly varying Bézier parameters (P_{U}, P_{L}) and the fixed linear scale range (LZ_{U}-LZ_{L}). Application of this constraint into Equations (1) and (2) achieves the desired matching gradients between the linear scale region 64 and the non-linear scale regions 66, 68.

In method step 212, the processor 34 then animates the tick-marks and parameter values along the scale axis 56 based on the determined display values. For example, the processor 34 may animate the linear tick-marks 70 to appear within the linear scale region 64 based on the upper linear scale value 86, the lower linear scale value 88, and the linear scale gradient. The processor 34 may also animate the first non-linear tick-marks 76 to appear within the first non-linear scale region 66 based on determined first display values, and animate the second non-linear tick-marks 78 to appear within the second non-linear scale region 68 based on the determined second display values. In some embodiments, the processor 34 animates corresponding parameter values adjacent one or more displayed tick-marks 54 within each of the scale regions 62. The processor 34 may also animate a current parameter value datum icon 94 within the linear scale region 64 indicating the received current parameter value 80.

In the illustrated embodiment, the processor 34 animates the first non-linear tick-marks 76 such that a gradient of the first non-linear tick-marks 76 displayed near the linear scale region 64 is equal to the linear scale gradient. For example, as shown in FIGS. 9 and 11, as first non-linear tick-marks 76 and corresponding parameter values are animated to move towards the linear scale region 64, the processor 34 displays the first non-linear tick-marks 76 and corresponding parameter values having a spacing that is substantially equal to the spacing of the linear tick-marks 70. Similarly, the processor 34 may also animate the second non-linear tick-marks 78 and corresponding parameter values such that a gradient of the second non-linear tick-marks 78 displayed near the linear scale region is substantially equal to the linear scale gradient. The processor 34 may also determine a predictor parameter value based on the received current parameter value 80 and animate a predictor icon 96 (shown in FIG. 8) to appear within the parameter scale 52 indicating the predictor parameter value.

For example, in the illustrated embodiment, the one or more processors 34 of the controller 26 are programmed to execute the algorithm 200 to display an animated sequence of computer-generated images on the GUI display screen including the steps of receiving a current parameter value 80 associated with an aircraft 24 and rendering the flight parameter display screen 38 on the GUI display screen including a hybrid dynamic non-linear display 12 displaying the current parameter value 80. The one or more processors 34 render the hybrid dynamic non-linear display 12 by establishing the upper end point anchor value 82 and the lower end point anchor value 84 based on the current parameter value 80 and rendering the parameter display tape 50 including the parameter scale 52 displaying the upper end point anchor value 82 and the lower end point anchor value 84 and including the linear scale region 64 displayed between the first non-linear scale region 66 and the second non-linear scale region 68 along the scale axis 56.

The one or more processors 34 also render the plurality of linear tick-marks 70 equally spaced within the linear scale region 64, renders the plurality of first non-linear tick-marks 76 unequally spaced within the first non-linear scale region 66, and renders the plurality of second non-linear tick-marks 78 unequally spaced within the second non-linear scale region 68.

The one or more processors 34 is also programmed to execute the algorithm 200 including the steps of establishing the linear scale gradient of the linear scale region 64, determining the upper linear scale value 86 and the lower linear scale value 88 of the linear scale region 64 based on the current parameter value 80 and the linear scale gradient. The one or more processors 34 then animate the linear tick-marks 70 to appear within the linear scale region 64 between the first linear scale end 72 and the opposite second linear scale end 74 based on the upper linear scale value 86, the lower linear scale value 88, and the linear scale gradient.

As shown in FIGS. 5 and 6, the one or more processors 34 execute the algorithm 200 including displaying the first non-linear scale region 66 between the first end 58 of the parameter scale 52 and the first linear scale end 72 of the linear scale region 64. The one or more processors 34 may then execute Equation (1) and Equation (3) to animate the plurality of first non-linear tick-marks 76 within the first non-linear scale region 66 such that first non-linear tick-marks 76 that are displayed near the first end 58 of the parameter scale 52 are spaced closer together than first non-linear tick-marks 76 that are displayed near the first linear scale end 72 of the linear scale region 64.

The one or more processors 34 may also execute the algorithm 200 including the steps of determining a plurality of first display values 90 associated with the first non-linear scale region 66 based on the lower end point anchor value 84 and the lower linear scale value 88 of the linear scale region 64 and animating the first non-linear tick-marks 76 to appear within the first non-linear scale region 66 based on determined first display values 90.

In some embodiments, as shown in FIG. 6, the one or more processors 34 may execute Equation (5), Equation (7), and Equation (8) to animate the first non-linear tick-marks 76 such that a gradient of first non-linear tick-marks 76 that are displayed near the first linear scale end 72 of the linear scale region 64 is substantially equal to the linear scale gradient.

The one or more processors 34 may also execute the algorithm 200 including displaying the second non-linear scale region 68 between the second linear scale end 74 of the linear scale region 64 and the second end 60 of the parameter scale 52. For example, the one or more processors 34 may execute Equation (2) and Equation (4) to animate the plurality of second non-linear tick-marks 78 within the second non-linear scale region 68 such that second non-linear tick-marks 78 displayed near the second end 60 of the parameter scale 52 are spaced closer together than second non-linear tick-marks 78 that are displayed near the second linear scale end 74 of the linear scale region 64.

The one or more processors 34 may also execute the algorithm 200 including the steps of determining a plurality of second display values 92 associated with the second non-linear scale region 68 based on the upper end point anchor value 82 and the upper linear scale value 86 of the linear scale region 64 and animating the second non-linear tick-marks 78 to appear within the second non-linear scale region 68 based on determined second display values 92.

In addition, the one or more processors 34 may execute Equation (6), Equation (7), and Equation (8) to animate the second non-linear tick-marks 78 such that a gradient of second non-linear tick-marks 78 that are displayed near the second linear scale end 74 of the linear scale region 64 is substantially equal to the linear scale gradient.

As shown in FIGS. 9 and 11, the one or more processors 34 may also render the display values 90, 92 as intermediate scale markings that appear and disappear within the scale regions 64, 68. For example, the one or more processors 34 may animate the non-linear tick marks 76, 78 and/or the display values 90, 92 to fade-in and fade-out over a period of 2-3 seconds.

As shown in FIG. 8 in the illustrated embodiment, the one or more processors 34 may also execute the algorithm 200 including the steps of receiving a first flight parameter value and a second flight parameter associated with the aircraft and rendering the flight parameter display screen 38 to include a first hybrid dynamic non-linear display 40 displaying the first flight parameter value and a second hybrid dynamic non-linear display 42 displaying the second flight parameter value. For example, the one or more processors 34 may display the first hybrid dynamic non-linear display 40 as an altimeter hybrid dynamic non-linear display indicating measured aircraft altitude and display the second hybrid dynamic non-linear display 42 as an airspeed hybrid dynamic non-linear display indicating measured aircraft airspeed.

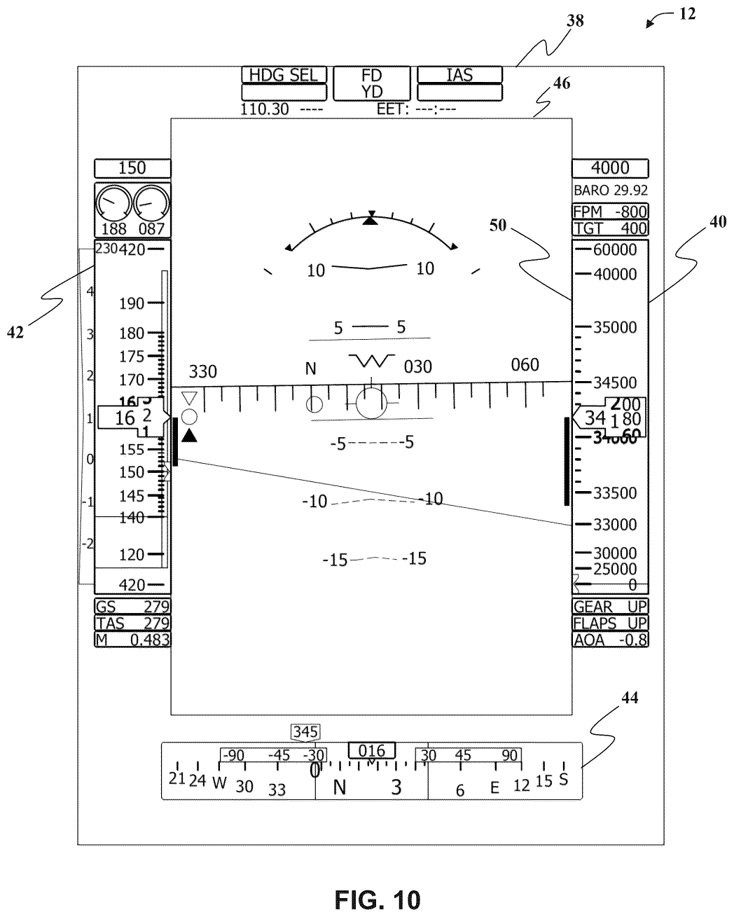

The one or more processors 34 may also render the flight parameter display screen 38 including the Pitch/Roll display window 46 indicating a pitch and roll of the aircraft displayed between the altimeter hybrid dynamic non-linear display 40 and the airspeed hybrid dynamic non-linear display 42, and renders the compass hybrid dynamic non-linear display 44 indicating measured aircraft heading below the Pitch/Roll display window 46, as shown in FIG. 10. As shown in FIG. 8, the one or more processors 34 may also render the flight parameter display screen 38 including the MACH hybrid dynamic non-linear display 48 indicating a determined MACH number associated with the measured aircraft airspeed displayed adjacent the airspeed hybrid dynamic non-linear display 42. For example, the one or more processors 34 may render the airspeed hybrid dynamic non-linear display 42 as the Master display and render the MACH hybrid dynamic non-linear display 48 as the Slave display by determining the scale values of the MACH hybrid dynamic non-linear display 48 based on the scale values of the airspeed hybrid dynamic non-linear display 42 such that the correct relationship is maintained between the displayed airspeed and Mach scale values.

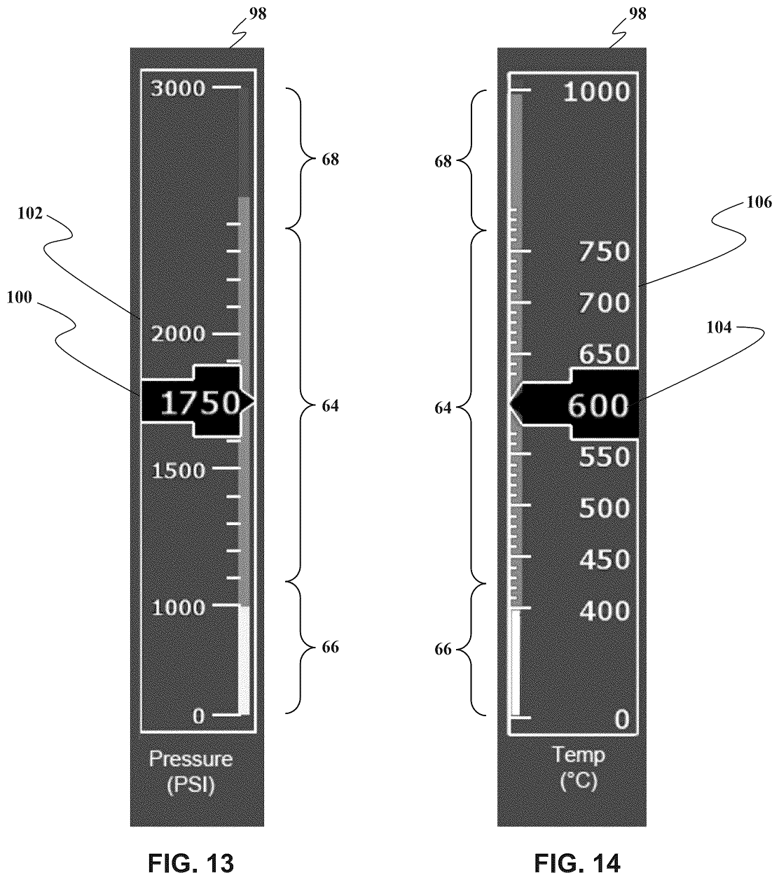

In some embodiments, the one or more processors 34 may be programmed to render the GUI display screen including a process control display 98 displaying hybrid dynamic non-linear displays illustrating measured industrial process parameters for use in an industrial plant. For example, as shown in FIG. 13, the one or more processors 34 may receive the current parameter value 80 including a measured industrial process parameter including a process pressure 100 and render the process control display 98 including a pressure hybrid dynamic non-linear display 102 indicating measured pressure. Similarly, as shown in the FIG. 14, the one or more processors 34 may receive the current parameter value 80 including the measured industrial process parameter including a measured process temperature 104 and render the process control display 98 including a temperature hybrid dynamic non-linear display 106 indicating measured temperature.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible media of expression having computer-usable program code embodied in the media.

Any combination of one or more computer-usable or computer-readable media (or medium) may be utilized. For example, a computer-readable media may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart and/or block diagram block or blocks.

Several (or different) elements discussed herein, and/or claimed, are described as being “coupled”, “in communication with”, or “configured to be in communication with”. This terminology is intended to be non-limiting, and where appropriate, be interpreted to include without limitation, wired and wireless communication using any one or a plurality of a suitable protocols, as well as communication methods that are constantly maintained, are made on a periodic basis, and/or made or initiated on an as needed basis. The term “coupled” means any suitable communications link, including but not limited to the Internet, a LAN, a cellular network, or any suitable communications link. The communications link may include one or more of a wired and wireless connection and may be always connected, connected on a periodic basis, and/or connected on an as needed basis.

A controller, computing device, server or computer, such as described herein, includes at least one or more processors or processing units and a system memory (see above). The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, MongoDB™ database engines which is a document storage solution, Oracle® Database, MySQL, IBM® Db2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

The above description of illustrated examples of the present invention, including what is described in the Abstract, are not intended to be exhaustive or to be limited to the precise forms disclosed. While specific embodiments of, and examples for, the invention are described herein for illustrative purposes, various equivalent modifications are possible without departing from the broader spirit and scope of the present invention.

The invention has been described in an illustrative manner. It is to be understood that the terminology which has been used is intended to be in the nature of words of description rather than of limitation. Many modifications and variations of the invention are possible in light of the above teachings. Therefore, within the scope of the appended claims, the invention may be practiced other than as specifically described.

What is claimed is:

1. An electronic instrument system comprising:
a display device including a graphical user interface (GUI) display screen displaying computer-generated images thereon; and
a controller operably coupled to the display device, the controller including one or more processors programmed to execute an algorithm to display an animated sequence of computer-generated images on the GUI display screen including the steps of:
receiving a current parameter value; and
rendering a parameter display screen on the GUI display screen including a hybrid dynamic non-linear display displaying the current parameter value by:
establishing an upper end point anchor value and a lower end point anchor value based on the current parameter value;
rendering a parameter display tape including a parameter scale displaying the upper end point anchor value and the lower end point anchor value and including a linear scale region displayed between a first non-linear scale region and a second non-linear scale region along a scale axis;
rendering a plurality of linear tick-marks equally spaced within the linear scale region;
rendering a plurality of first non-linear tick-marks unequally spaced within the first non-linear scale region; and
rendering a plurality of second non-linear tick-marks unequally spaced within the second non-linear scale region.

2. The electronic instrument system of claim 1, wherein the one or more processors is programmed to execute the algorithm including the steps of:
establishing a linear scale gradient of the linear scale region with a required resolution;
determining an upper linear scale value and a lower linear scale value of the linear scale region based on the current parameter value and the linear scale gradient; and
animating the linear tick-marks to appear within the linear scale region between a first linear scale end and an opposite second linear scale end based on the upper linear scale value, the lower linear scale value, and the linear scale gradient.

3. The electronic instrument system of claim 2, wherein the one or more processors is programmed to execute the algorithm including the steps of:
displaying the first non-linear scale region between a first end of the parameter scale and the first linear scale end of the linear scale region;
animating the plurality of first non-linear tick-marks within the first non-linear scale region such that first non-linear tick-marks displayed near the first end of the parameter scale are spaced closer together than first non-linear tick-marks displayed near the first linear scale end of the linear scale region; and
animating the first non-linear tick-marks such that a gradient of first non-linear tick-marks displayed near the first linear scale end of the linear scale region is substantially equal to the linear scale gradient.

4. The electronic instrument system of claim 3, wherein the one or more processors is programmed to execute the algorithm including the steps of:
displaying the second non-linear scale region between the second linear scale end of the linear scale region and a second end of the parameter scale;
animating the plurality of second non-linear tick-marks within the second non-linear scale region such that second non-linear tick-marks displayed near the second end of the parameter scale are spaced closer together than second non-linear tick-marks displayed near the second linear scale end of the linear scale region; and
animating the second non-linear tick-marks such that a gradient of second non-linear tick-marks displayed near the second linear scale end of the linear scale region is substantially equal to the linear scale gradient.

5. The electronic instrument system of claim 2, wherein the one or more processors is programmed to execute the algorithm including the steps of:
determining a plurality of first display values associated with the first non-linear scale region based on the lower end point anchor value and the lower linear scale value of the linear scale region; and
animating the first non-linear tick-marks to appear within the first non-linear scale region based on determined first display values.

6. The electronic instrument system of claim 5, wherein the one or more processors is programmed to execute the algorithm including the steps of:
determining a plurality of second display values associated with the second non-linear scale region based on the upper end point anchor value and the upper linear scale value of the linear scale region; and
animating the second non-linear tick-marks to appear within the second non-linear scale region based on determined second display values.

7. The electronic instrument system of claim 6, wherein the one or more processors is programmed to execute the algorithm including the steps of:
animating the first and second display values as intermediate scale markings that appear and disappear within the non-linear scale regions.

8. The electronic instrument system of claim 6, wherein the one or more processors is programmed to execute the algorithm including the steps of:
determining the first and second display values using a quadratic Bezier curve.

9. The electronic instrument system of claim 1, wherein the one or more processors is programmed to execute the algorithm including the steps of:
receiving a first flight parameter value and a second flight parameter value associated with an aircraft; and
rendering the parameter display screen including a first hybrid dynamic non-linear display displaying the first flight parameter value and a second hybrid dynamic non-linear display displaying the second flight parameter value.

10. The electronic instrument system of claim 9, wherein the one or more processors is programmed to execute the algorithm including the steps of:
displaying the first hybrid dynamic non-linear display as an altimeter hybrid dynamic non-linear display indicating measured aircraft altitude; and
displaying the second hybrid dynamic non-linear display as an airspeed hybrid dynamic non-linear display indicating measured aircraft airspeed.

11. The electronic instrument system of claim 10, wherein the one or more processors is programmed to execute the algorithm including the steps of:
rendering the parameter display screen including a Pitch/Roll display window indicating a pitch and roll of the aircraft displayed between the altimeter hybrid dynamic non-linear display and the airspeed hybrid dynamic non-linear display.

12. The electronic instrument system of claim 11, wherein the one or more processors is programmed to execute the algorithm including the steps of:
rendering the parameter display screen including a MACH hybrid dynamic non-linear display indicating a determined MACH number associated with the measured aircraft airspeed.

13. The electronic instrument system of claim 11, wherein the one or more processors is programmed to execute the algorithm including the steps of:
rendering the parameter display screen including a compass hybrid dynamic non-linear display indicating measured aircraft heading.

14. The electronic instrument system of claim 1, wherein the one or more processors is programmed to execute the algorithm including the steps of:
receive the current parameter value including a measured industrial process parameter; and
rendering the hybrid dynamic non-linear display based on the measure industrial process parameter.

15. A method of operating an electronic instrument system including a display device including a graphical user interface (GUI) display screen displaying computer-generated images thereon and one or more processors operably coupled to the display device, the method including the one or more processors performing an algorithm to display an animated sequence of computer-generated images on the GUI display screen including the steps of:
receiving a current parameter value; and
rendering a parameter display screen on the GUI display screen including a hybrid dynamic non-linear display displaying the current parameter value by:
establishing an upper end point anchor value and a lower end point anchor value based on the current parameter value;
rendering a parameter display tape including a parameter scale displaying the upper end point anchor value and the lower end point anchor value and including a linear scale region displayed between a first non-linear scale region and a second non-linear scale region along a scale axis;
rendering a plurality of linear tick-marks equally spaced within the linear scale region;
rendering a plurality of first non-linear tick-marks unequally spaced within the first non-linear scale region; and
rendering a plurality of second non-linear tick-marks unequally spaced within the second non-linear scale region.

16. The method of claim 15, including the one or more processors performing the algorithm including the steps of:
establishing a linear scale gradient of the linear scale region with a required resolution;
determining an upper linear scale value and a lower linear scale value of the linear scale region based on the current parameter value and the linear scale gradient; and
animating the linear tick-marks to appear within the linear scale region between a first linear scale end and an opposite second linear scale end based on the upper linear scale value, the lower linear scale value, and the linear scale gradient.

17. The method of claim 16, including the one or more processors performing the algorithm including the steps of:
displaying the first non-linear scale region between a first end of the parameter scale and the first linear scale end of the linear scale region;
animating the plurality of first non-linear tick-marks within the first non-linear scale region such that first non-linear tick-marks displayed near the first end of the parameter scale are spaced closer together than first non-linear tick-marks displayed near the first linear scale end of the linear scale region; and
animating the first non-linear tick-marks such that a gradient of first non-linear tick-marks displayed near the first linear scale end of the linear scale region is substantially equal to the linear scale gradient.

18. The method of claim 17, including the one or more processors performing the algorithm including the steps of:
displaying the second non-linear scale region between the second linear scale end of the linear scale region and a second end of the parameter scale;
animating the plurality of second non-linear tick-marks within the second non-linear scale region such that second non-linear tick-marks displayed near the second end of the parameter scale are spaced closer together than second non-linear tick-marks displayed near the second linear scale end of the linear scale region; and
animating the second non-linear tick-marks such that a gradient of second non-linear tick-marks displayed near the second linear scale end of the linear scale region is substantially equal to the linear scale gradient.

19. A non-transitory computer-readable storage media having computer-executable instructions embodied thereon for operating an electronic instrument system including a display device including a graphical user interface (GUI) display screen displaying computer-generated images thereon and one or more processors operably coupled to the display device, when executed by the one or more processors the computer-executable instructions cause the one or more processors to perform an algorithm to display an animated sequence of computer-generated images on the GUI display screen including the steps of:
receiving a current parameter value; and
rendering a parameter display screen on the GUI display screen including a hybrid dynamic non-linear display displaying the current parameter value by:
establishing an upper end point anchor value and a lower end point anchor value based on the current parameter value;
rendering a parameter display tape including a parameter scale displaying the upper end point anchor value and the lower end point anchor value and including a linear scale region displayed between a first non-linear scale region and a second non-linear scale region along a scale axis;
rendering a plurality of linear tick-marks equally spaced within the linear scale region;
rendering a plurality of first non-linear tick-marks unequally spaced within the first non-linear scale region; and
rendering a plurality of second non-linear tick-marks unequally spaced within the second non-linear scale region.

20. The non-transitory computer-readable storage media of claim 19, wherein the computer-executable instructions cause the one or more processors to perform the algorithm including the steps of:
establishing a linear scale gradient of the linear scale region;
determining an upper linear scale value and a lower linear scale value of the linear scale region based on the current parameter value and the linear scale gradient;
animating the linear tick-marks to appear within the linear scale region between a first linear scale end and an opposite second linear scale end based on the upper linear scale value, the lower linear scale value, and the linear scale gradient;
animating the plurality of first non-linear tick-marks within the first non-linear scale region such that first non-linear tick-marks displayed near a first end of the parameter scale are spaced closer together than first non-linear tick-marks displayed near the first linear scale end of the linear scale region; and
animating the plurality of second non-linear tick-marks within the second non-linear scale region such that second non-linear tick-marks displayed near a second end of the parameter scale are spaced closer together than second non-linear tick-marks displayed near the second linear scale end of the linear scale region.
